(19) United States
(12) Patent Application Publication
(10) Pub. No.: US 2008/0192658 A1
(43) Pub. Date: Aug. 14, 2008

(54) Media distribution system with wireless local area network module

(76) Inventors: Kuo Ching Chiang, Linkou Township (TW); Yi Chuan Cheng, Yongjing Township (TW)

Correspondence Address: BIRCH STEWART KOLASCH & BIRCH, PO BOX 747, FALLS CHURCH, VA, 22040-0747, US

(21) Appl. No.: 11/704,250

(22) Filed: Feb. 9, 2007

(51) Int. Cl. H04Q 11/00

(52) U.S. Cl. 370/270

(57) ABSTRACT

A multimedia distribution system comprises a control terminal having a decoder to decode a data from a data source, a tuner coupled to the data source to select a channel, a first WLAN module coupled to the decoder or the data source to transfer data; at least one client with a second WLAN module coupled to the first WLAN module, and a data output coupled to the second WLAN module to output the data.

### FIELD OF THE INVENTION

The present invention relates to a media system, particularly to a media distribution system that is capable of providing audio or video service via wireless local area network (WLAN).

### BACKGROUND OF THE INVENTION

Because of the development of the information technology (IT), the information could be exchanged with higher capacity and faster speed. Internet is designed as an open structure to exchange information freely without restriction. Thus, certain communication service requiring real time information exchange, such as viewing a live video, has become feasible through Internet. The wireless protocol is a popular protocol about the transmission of data packets. Conventionally, the operators are needed to obtain media system lines from media companies for linking themselves to a media system.

Currently, all of the wireless protocols are implanted in the computer system. The user has to power on the computer system while the user would like to play audio/video signals through the internet. Therefore, the applications of the wireless protocols are still constrained within the computer. The general home user fails to benefit from the internet. It is inconvenient to the user.

### SUMMARY OF THE INVENTION

The present invention may achieve the media distribution system (MDS) that allows the user watching program or listing music at different locations by employing the identical control unit. The data are decoded by the identical control center prior to sending the information to the client terminal by WLAN module. Further, the client terminal may remote control the channel selection via the client terminal. Thus, the present invention offers the service of on demand TV or radio.

The present invention provides a multimedia distribution system comprising a control terminal having a decoder to decode a data from a data source, a tuner coupled to the data source to select a channel, a first WLAN module coupled to the decoder or the data source to transfer data; at least one client with a second WLAN module coupled to the first WLAN module, and a data output coupled to the second WLAN module to output the data.

The wireless local area network (WLAN) module includes Bluetooth standard compatible module, Wi-Fi standard compatible module, 802.11x standard compatible module, WiMAX (Worldwide Interoperability for Microwave Access) standard compatible module. Data includes audio signal, video signal, digital data and the combination thereof.

Another aspect of the present invention discloses a portable device employed to process an audio or video file comprising: a processing unit embedded in the portable device; an input unit and a speaker coupled to the processing unit, respectively; a memory coupled to the processing unit to store data; a WLAN module coupled to the processing unit for wireless communication with an external device to transfer information; a real time play module coupled to the processing unit to download data streams from a remote terminal and play the data streams in a real time playing mode.

The present invention discloses a method of playing a real time playing mode via a portable device, comprising: implanting a real time play module and a WLAN module to the portable device to allow a user performing a real time playing; coupling a content service provider via the WLAN module; activing the real time play module to couple to the content service provider; selecting a desired audio or video file through the real time play module; transmitting data streams from the content service provider to the portable device; and playing the data streams.

The present invention discloses a method of playing a real time playing mode via WLAN module, comprising: implanting first and second WLAN module to a control terminal and a client terminal, respectively; inputting instruction from the client terminal to the control terminal via the first and second WLAN module; performing the instruction; sending a data to the client terminal; and outputting the data.

The instruction is input by in lieu of an instruction input interface for selecting a desired channel or linking an internet network. The method further comprises performing a step of decoding the data from a remote data source after performing the instruction.

### BRIEF DESCRIPTION OF THE DRAWING

For a better understanding of the present invention and to show how it may be implemented, reference will now be made to the following drawings:

FIG. 1 is a multimedia distribution system of the present invention.

FIG. 2 is a block diagram showing the multimedia distribution system of the present invention.

FIG. 3 is a flow chart of performing process of the multimedia distribution system according to the present invention.

FIG. 4 shows a block diagram of a media player.

FIG. 5 shows a media player system.

FIG. 6 shows a block diagram of a media player.

FIG. 7 is a flow chart of playing a real time playing mode via a portable device according to the present invention.

FIG. 8 illustrates an album media.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

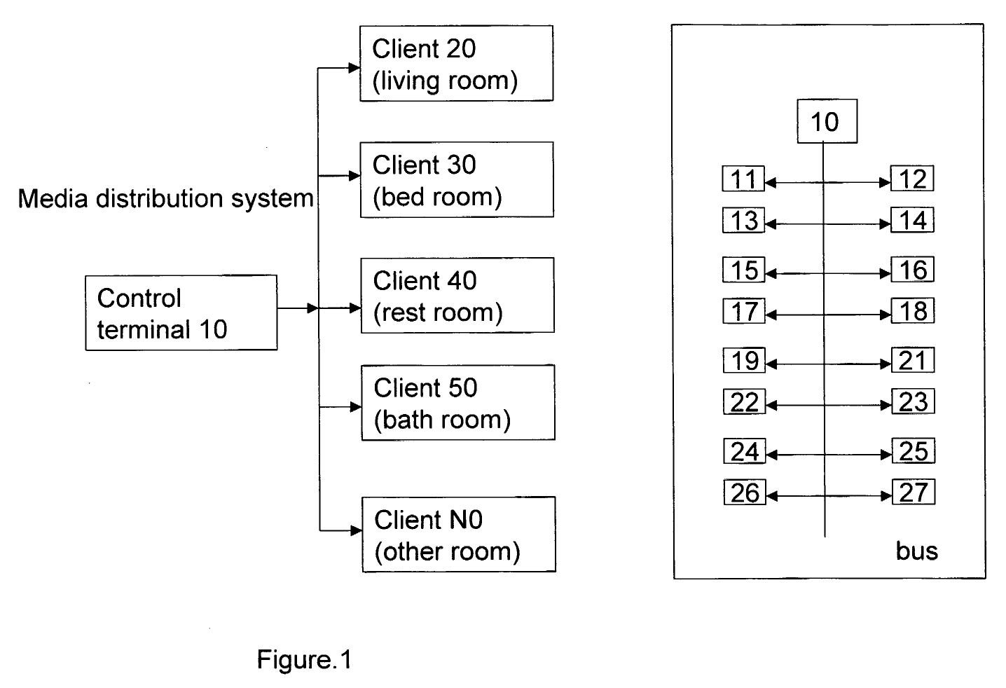

In FIG. 1, the present invention discloses a multimedia distribution system which comprises a control terminal and at least one client terminal. In one case, it may process a wireless local area network (WLAN) protocol. It should be noted that the control terminal 10 transmits and receives real-time data for client terminals via wireless local area network (WLAN) module, vice versa. For instance, the client terminal may be located at restricted space, for instance a living room 20, a bed room 30, a rest room 40, a bath room 50 . . . and other room NO. Moreover, the client terminal may be applied to public transportation (vehicles) including a bus, train, boat . . . or airplane which has a multiple application terminals 11, 12, 13, 14, 15, 16, 17, 18, 19, 21, 22, 23, 24, 25, 26 and 27 or more; or airport, restaurant, movie house, hospital, school, art house, office, gallery, plant, foundry . . . Accordingly, it could be the bulletin board for these places.

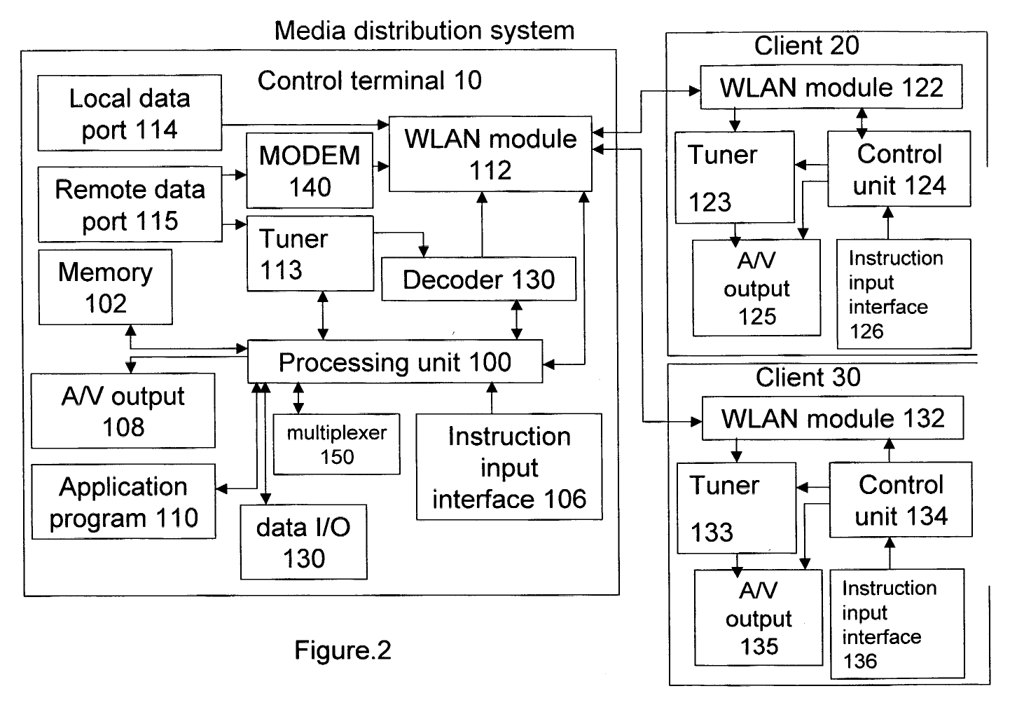

Referring to FIG. 2, it illustrates the functional diagram of the multimedia distribution system of the present invention with implementing audio, video or electronic bulletin board capability. The diagram is used for illustrating and not used for limiting the scope of the present invention. In general, the control terminal 10 receives data from a remote data source or a local data source via a remote data (signals) port 115 and a local data port 114, respectively. The remote data source include digital TV, SAT TV, web-TV, web site, internet media or internet network streams data. The data include audio, video or text data. The local data source includes DVD player, VCD player, MPEG player, WAN player coupled to WLAN module for transferring data. A selector 113 is used to select desired data or channel, in the case of TV, the selector could be a tuner 113. Some of the remote data source should be coupled to the selector or tuner 113 to select desired channel or data, for example, digital TV, SAT TV source. In the case of local data source, the selector 113 is used to select desired or favor song, title, sub-title. In the case of web media, the tuner 113 may be not necessary.

For example, if a signal modulated, for instance in a VSB/QAM mode, and received through an antenna (or cable), a tuner 113 selects a desired channel frequency and then demodulating the signal. Then, the tuner 113 converts the signal of a band inserted in the channel frequency to a first intermediate frequency (IF) band, and outputs to an analog processor. The analog processor performs passband filtering and gain controlling to the first if the signal outputted from the tuner 113 for converting the first IF signal into a second IF signal, and outputs to an AND (Analog/Digital) converter. Besides, the audio/video data might be abundant; therefore they could be compressed before transmitting. The signals conversion and compression processing technologies of digital TV are well known to the ordinary people skilled in related art; therefore the detailed descriptions are omitted to prevent from obscuring the present invention. The tuner 113 is coupled to the decoder 130.

In satellite television systems, the input signal spectrum can be, for example, 32 transponder channels between 950 MHz and 2150 MHz with each transponder channel carrying a number of different program channels. This signal spectrum can be processed by the receiver/tuner 113 to provide digital baseband output signals that represent a tuned transponder channel. These output signals can then be processed by a demodulator that can tune one of the program channels within the tuned transponder channel. The output signal from the demodulator, which represents a tuned program channel within the transponder channel that was tuned by the receiver/tuner 113, can then be processed with a (forward error correction) decoder 130 to produce a digital output stream. This digital output stream is typically the data stream that stored by personal video recorders (PVRs) for later use and viewing by a user as represented by the PVR output stream. The output of the decoder 130, or the stored PVR data as represented by PVR input stream, can then be processed by video/audio processing circuitry that can include processing circuitry such as a MPEG decoder. The output of the processing circuitry is typically the digital video data stream that represents the program channel and is used for picture-in-picture (PnP) operations, for example, where the set-top box circuitry includes two tuners with one tuner providing the primary viewing feed and a second tuner providing the PnP viewing feed. The output of the processing circuitry, as well as a PnP input stream from a second tuner if a second tuner is being utilized for PnP operations, can be processed by a video/audio controller to generate a video output signal that can subsequently be utilized, for example, with a TV or VCR. Additional tuners could also be used, if desired.

As an applied example of the present invention, it can play the role of an electronic bulletin board which may be utilized as an advertising medium. For example, an operator of the electronic bulletin board collects advertisement posting charges, and stores data of advertisement, which are consigned to post by an advertiser, and a URL (Uniform Resource Locator) for obtaining a homepage, which posts the advertisement and information of the advertiser. Accordingly, a reader of the bulletin board can read an advertisement. Thereby, the bulletin board provided by the electronic bulletin board can function as the advertisement medium. The system is therefore can be used in the transportation station to display the bus schedule. Similarly, other web media such as web TV, digital radio station, content service provider and network service provider can also be distributed through the present invention.

As known, the multimedia distribution system usually includes a final actuators, i.e. display for AN (Audio, Video) output 108, for example including CRT, LCD (liquid crystal device panel), PDP, RPTV, PDP. The display may display channel and channel data. Instruction input interface, such as remote receiver or touch panel, 106 is used to receive the instruction signal from a remote controller or instruction of the user. Typically, the instruction input interface 106 receives the instruction of the remote controller and transfers the instruction to a processing unit 100 for processing the signal.

The control terminal 10 includes converter (A/D, D/A) for converting the data from digital to analog, vice versa. The present invention includes a processing unit 100, a build-in display for AN (Audio, Video) output 108 and memory 102. AN (Audio, Video) output 108 is coupled to a processing unit 100. The memory 102 can be a ROM program memory, a RAM memory or a nonvolatile FLASH memory. All of the units mentioned above are coupled to the processing unit 100, respectively. The memory could be micro-type hard disc as well. A data I/O interface 130 is coupled to the processing unit 100 for exchanging information, such as TV program information, application software, updating version of WLAN program. The data I/O interface 130 could be USB, IEEE1394. In one embodiment, the MPEG (MP3, MP4) or WAN file can be stored in the memory or hard disc 102, the stored filed can be decoded and sent to the WLAN.

A WLAN module 112 is coupled to the processing unit 100 to allow the control terminal 10 transmitting and receiving the audio, video or internet type signals to/from WLAN modules 122, 132 and the remote data source. In one case, the WLAN module 112 may meet the standard Protocol, it's update version or the like. Multiplexer or de-multiplexer 150 is required and coupled to the processing unit 100 to multiplexer or de-multiplexer the audio/video data if the client 20, 30 or more would like to conduct the real-time (audio/video) data transmission. Moreover, an interleaver or de-interleaver is required in some cases. Therefore, the real-time playing is possible to be held through the WLAN module.

Data multiplexer 150, for multiplexing audio data, video data and additional data for digital television broadcasting, generally includes video encoder, audio encoder, subtitle encoder, a multiplexing system, and a control system. The multiplexing system may include FIFO memories, a RAM, switch circuits, and a SCSI (small computer system interface) circuit. The control system may include data size counting interface circuits, an ethernet interface (ENIF) circuit, a serial interface (SIF) circuit, a CPU, a processing RAM, and a control data RAM, which may be coupled together through a CPU bus. Typically, the multiplexer 150 is necessary for multiplexing audio data, video data. They are not the features of the present invention, the detailed description is omitted. It is appreciated that it will be understood by the ordinary people skilled in the art.

A MODEM 140 is coupled to the remote data port (for example internet port) to modulate or demodulate the transmitted data to allow the media distribution system coupling to the internet. The demodulated data will be transmitted to the WLAN of the media distribution system.

In another embodiment, the system further includes a wireless local area network (WLAN) module 122, 132 coupled to control unit 124, 134, respectively. An antenna is provided to couple to the wireless local area network (WLAN) module 122, 132 for transmitting or receiving signal from WLAN (wireless local area network) 112, as shown in FIG. 2. The media distribution system may couple to the internet via the WLAN module 112, 122, 132 to upload or download data including digital data such as text format, image format, audio signal, video signal. The application of the apparatus is quite economical and convenience.

Further, the present invention provides dual way (transmission and receiving) audio/video playing, synchronously. The user may employ the media distribution system to synchronously transmit and receive the vocal, video or both signal through the WLAN module 112, 122, 132. The client terminal may include a mobile phone, PDA, media player, media display (as set in FIG. 2), computer and so on.

One aspect of the present invention, the wireless local area network (WLAN) module could be compatible to the local area network protocol or standard such as Bluetooth standard, Wi-Fi standard or 802.11x standard compatible module. Further, the wireless local area network (WLAN) module could be compatible to the WiMAX (Worldwide Interoperability for Microwave Access) standard. Typically, the WLAN module may include transceiver, base-band unit, digital signal processing etc. The WLAN module is well known in the art, the detailed description is omitted.

The communication protocol of the wireless communication can be Bluetooth standard, Wi-Fi standard or 802.11x standard compatible module. Further, the wireless local area network (WLAN) module could be compatible to the WiMAX (Worldwide Interoperability for Microwave Access) standard.

Therefore, the present invention may perform a real time playing via the wireless local area network (WLAN) module.

As known, the control terminal 10 may include application program 110, for instance OS, application software, web browser or e-mail program etc. The application program 110 allows the control terminal 10 or client terminals 20, 30 linking to web or processing e-mail for transferring data. The software program is not the feature of the present invention, the description is omitted. Alternatively, the control terminal 10 may employ the MODEM or WLAN 112 to couple to the internet for data transferring. Alternatively, the client may include application program, OS, web browser or e-mail program etc.

Similarly, the client 20, 30 usually include a final actuators, i.e. display for AN (Audio, Video) output 125, 135, for example including CRT, LCD (liquid crystal device panel), PDP, RPTV, PDP. AN (Audio, Video) output 125, 135 are coupled to a control unit 124, 134, respectively. The remote receivers 126, 136 coupled to the control unit 124, 134 are used to receive the instruction signal from a remote controller. Typically, the device 126, 136 receive the instruction of the remote controller and transfers instruction to the control unit 124, 134 for processing the signal. Moreover, tuners 123, 133 are optionally embedded in the client 20 and 30, respectively.

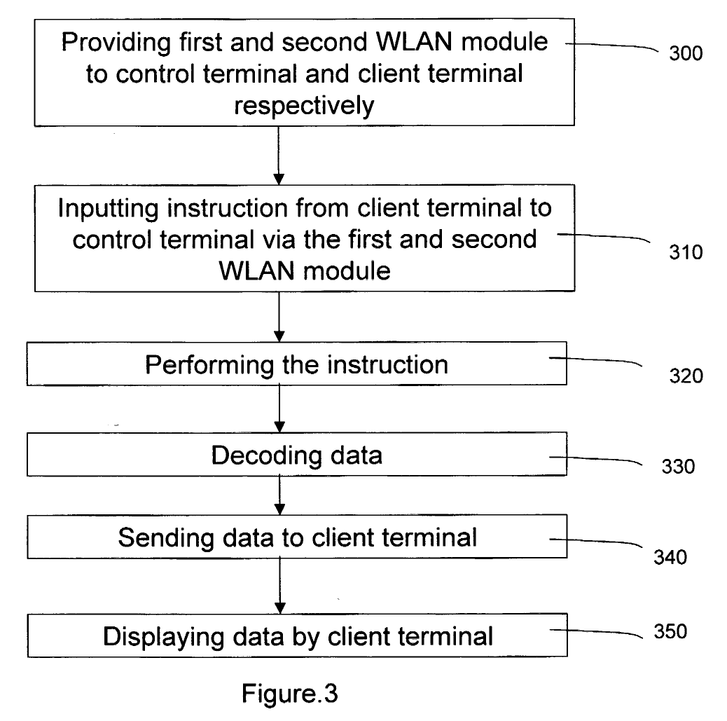

Referring to FIG. 3, it illustrates a flow chart of performing process of the multimedia distribution system of the present invention. The flow chart is used for illustrating and not used for limiting the scope of the present invention. Firstly, the step 300 is performed which implanting first and second WLAN module to control terminal and client terminal, respectively. In this step, WLAN module may transmit or receive data to/from the control terminal and the client terminal. Subsequently, the step 310 is executed which inputting instruction from client terminal to control terminal via the first and second WLAN module. In the step, the client terminal inputs an instruction, for instant selecting a desired channel or linking an internet network, to control unit, and then performing the instruction, in the step 320. Next, decoding data provided by a remote data source is performed in the step 330. In a local data source, data decoding step is unnecessary. And then, the data is sent to the client terminal, for example through WLAN module, in the step 340. Finally, the data is outputting and displaying on the client terminal in the step 350.

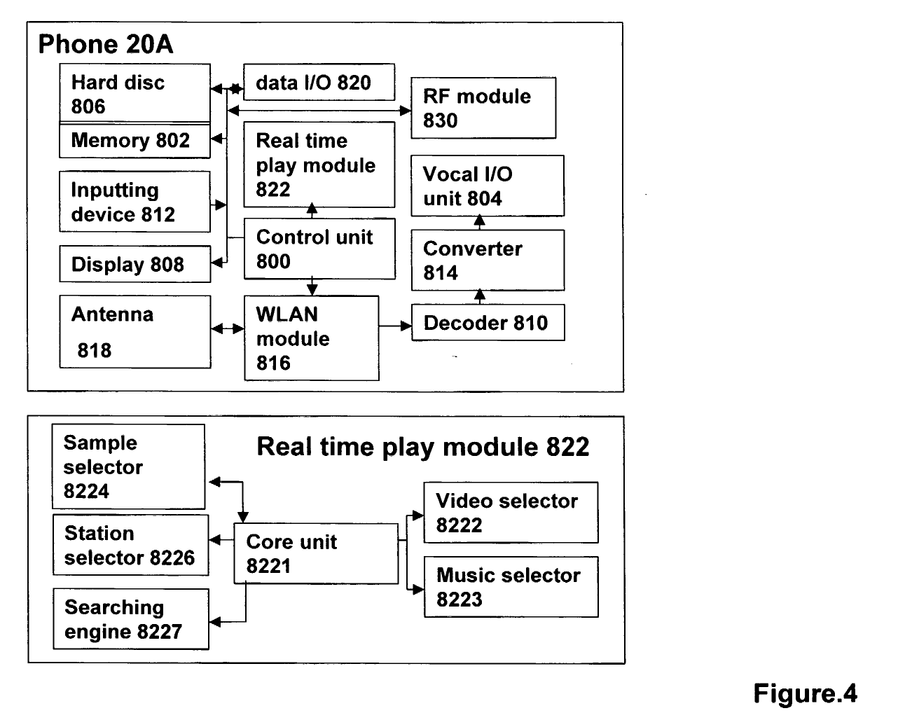

Moreover, the present invention relates to a portable and hand-held communication device or media player. FIG. 4 shows a block diagram of a media player 20A. The diagram is used for illustrating and not used for limiting the scope of the present invention. The portable terminal or device 20A includes a RF module 830. As know in the art, the RF signal transmission module includes antenna (not shown) to transmit and receive mobile phone signal through the network. This antenna is connected to a transceiver, which is used to receive and transmit signal. The A/D convert coupled to the speaker is used to converted data between digital and analog as known in the art. The RF module 830 is not the feature of the present invention; therefore, the detailed description is omitted. The present invention includes a central control unit 800, an input unit 812, a build-in display 808, OS, hard disk 806 and memory 802 including a ROM program memory, a RAM memory. All of the components are coupled to the control unit 800 via buses. Nonvolatile FLASH memory is coupled to the control unit 800. The RF module may perform the function of signal transmitting and receiving, frequency synthesizing, base-band processing and digital signal processing. The SIM card hardware interface is used for receiving a SIM card. Finally, the signal is send to the final actuators, i.e. a loudspeaker and a microphone 804.

A data I/O 820 is provided and coupled to the control unit 800. The data I/O 820 is capable of coupling to the I/O port of an external device such as computer system, directly or indirectly. The data 1/O 820 provides the interface for exchanging the information between the portable device and the computer system (or the access point). The data I/O 820 is preferably USB (universal serial bus) interface, Fire Wire interface or the IEEE 1394. The USB or the Fire Wire is provided and coupled to the control unit 800. Through the USB interface or the Fire Wire, the user may transfer or update data such as E-mail, MP3 file, image file or downloaded data by employing the control unit of the device. Based above, the control unit of the embodiment may process the MPEG file (audio and/or video file) or e-mail data.

Further, the present invention also includes a wireless local area network (WLAN) module 816 for short range data transmission or reception between the hand-held device and an external device such as access point or computer (local or remote terminal) via network. The WLAN may transfer data, information between the device 20A and the external device. Thus, the device may employ the WLAN module 816 to receive or exchange data from remote terminal. The WLAN module 816 includes 802.11 standard (802.11a, 802.11b, 802.11g, 802.11n), Bluetooth standard or WiMax. In general, the WLAN module 816 allows the device couple to the internet via access point, gateway or computer. An antenna 818 is coupled to the WLAN module 816 to transmit and receive signal. A decoder 810 is connected to the WLAN module 816, and a converter 814 is coupled to the decoder 810. The decoder 810 is used to decode the file such as MP3, MP4 file. The converter 814 is employed to convert signal between digital and analog. Finally, the signal is send to the final actuators, i.e. a loudspeaker and a microphone 804.

The present invention includes a real time play module 822 embedded in the portable device or player. Turning to FIG. 4, the real time playing module 822 allows the device 20A download audio or video data from a remote terminal. The real time play module 822 only downloads the data temporally, and the data will be removed from the memory of the device to achieve the real play effect. The module 822 includes code unit 8221 which is the core of the program to allow the device to couple to the content service provider and downloads data there-from. The real time play module 822 also includes video selector 8222 and music selector 8223 coupled to the core unit 8221 for the user to select the desired file to be down load. A sample selector 8224 is employed to select the sample from the content service provider. A station selector 8225 is coupled to the core unit 8221 for the user to select the TV station, radio station and so on. A searching engineer 8226 allows the user to search items.

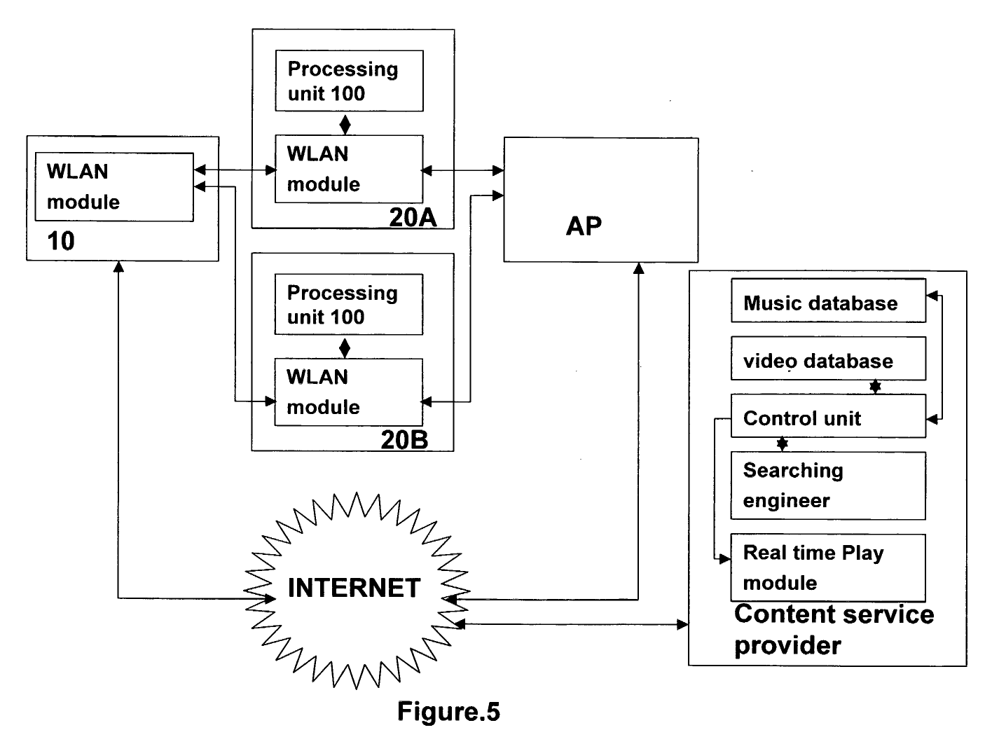

The device 20A, 20B may couple to the internet via the AP or the host 10, please refer to FIG. 5. The content service provider includes a control unit, a music database and a video database coupled to the control unit. A real time play module is coupled to the control unit to allow the data streams or file to be downloaded.

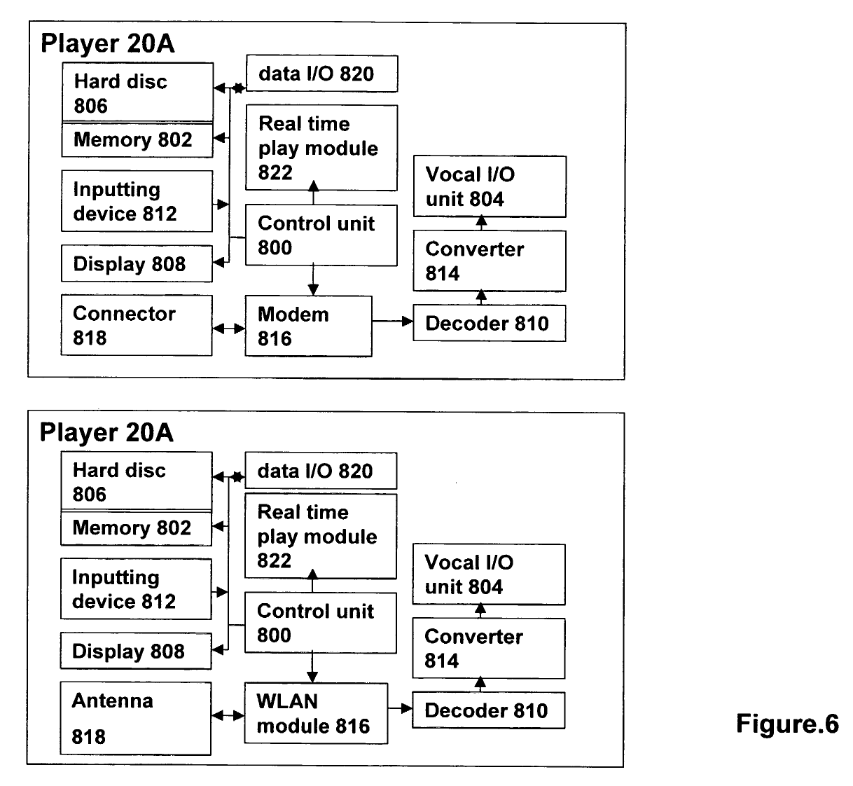

Please refer to the FIG. 6, the embodiment is similar to the FIG. 4. The embodiment may be performed without the RF communication module, it may omit some components. Therefore, the present invention may employ the control unit 100, WLAN module to wireless transfer data from the content service provider. According to the present invention, the hand-held portable device may wirelessly download file through WLAN module from an external device via the network and plays the music or video data by the way of real-time playing mode. The storage of the player is limited, the user may only store the favor file and other files maybe provided by the content service provider immediately, while the user couples to the service provider. The user may enjoy the digital music and video wirelessly and achieve the real-play performance. The user will not be interrupted by the wire during listing the audio file processed by the device 10. The present invention may transfer data between the external device and the present device 10. The external device includes but not limited to an access point, gateway, router, wireless earphone, local or remote computer. The WLAN module could be replaced by MODEM 816 and connector 818.

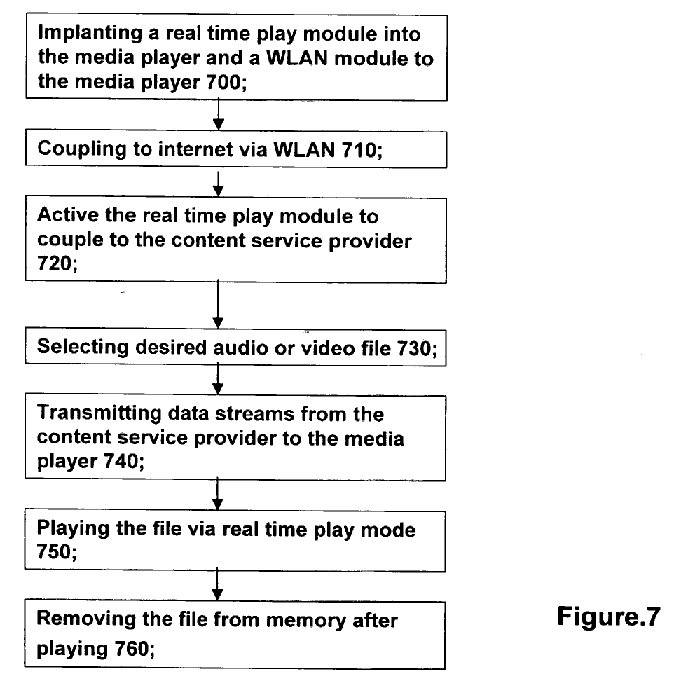

The method can be found in FIG. 7, the method includes the steps of:

700: the present invention implants a real time play module and a WLAN module to the media player to allow the user may employs the player to perform a real-time play performance; and the media player coupling the content service provider via the WLAN module in the step 710. The next step 720 is to active the real time play module to couple to the content service provider. The user may select a desired audio or video file through the real-play module while the player is coupled to the content service provider. Then, the content service provider may transmit data streams from the content provider to the media player in step 740 when the content service provider receives the signal. The file is played via the real time play mode (module) in step 750, and the file is removed from memory of the player after playing 760. The data stream is processed by the first-in-first-out (FIFO) scheme.

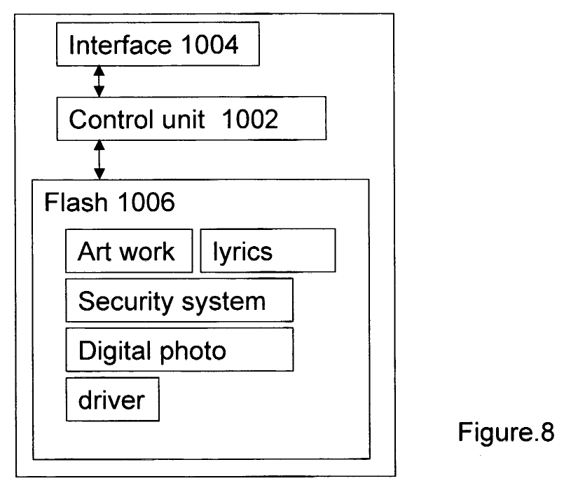

FIG. 8 illustrate an album media 1000 to store the art work of the artistic, singer, movie to replace the conventional DVD. The album media 1000 allows the user to watch movie or listen to the music from the mobile terminal. The album media 1000 includes a housing to carry a control unit 1002 and/or circuit board (not shown). An interface 1004 is coupled to the control unit 1002 for data input or output. A memory 1004 such as flash is coupled to the control unit 1002. The memory includes the work, digital photo album and/or lyrics file produced by the artistic, signal, the music company, studio or presented by a movie making company. A security system is embedded in the memory 1006 to encrypts the files and data in the album media 1000. The security system may offer the transparent encryption technology to protect the art work in the media to prevent unauthorized usage. The user may input the password to decode the file in the media for protection. The encryption method includes PKI, RSA, Blowfish,Triple DES, DES, IDEA, RC5, CAST-128 or RC2. The media further includes application drive and program stored in the memory.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A multimedia distribution system comprising:
a control terminal having a decoder to decode a data from a data source, a selector coupled to said data source to select a desired data, a first WLAN module coupled to said decoder or said data source to transfer data;
at least one client with a second WLAN module coupled to said first WLAN module, and a data output coupled to said second WLAN module to output said data.

2. The system as set forth in claim 1, wherein said at least one client further comprises an instruction input interface.

3. The system as set forth in claim 1, wherein said first and second wireless local area network (WLAN) module includes Bluetooth standard compatible module, Wi-Fi standard compatible module, 802.11x standard compatible module, WiMAX (Worldwide Interoperability for Microwave Access) standard compatible module.

4. The system as set forth in claim 1, wherein said data source include local data source including DVD player, VCD player, MPEG player, WAN player, and remote data source including SAT TV, digital TV, web-TV, content service provider or network service provider.

5. The system as set forth in claim 1, wherein said control terminal further comprises a multiplexer or de-multiplexer.

6. The system as set forth in claim 1, wherein said control terminal further comprises a MODEM.

7. A portable device employed to process an audio or video file comprising:
a processing unit embedded in said portable device;
an input unit and a speaker coupled to said processing unit, respectively;
a memory coupled to said processing unit to store data;
a WLAN module coupled to said processing unit for wireless communication with an external device to transfer information;
a real time play module coupled to said processing unit to download data streams from a remote terminal and play said data streams in a real time playing mode.

8. The portable device of claim 7, wherein said WLAN module includes 802.11x, Bluetooth or WiMax.

9. The portable device of claim 7, wherein said real time play module further comprises a core unit for performing said real time playing mode, a video selector and a music selector coupled to said core unit, a station selector coupled to said core unit.

10. The portable device of claim 7, wherein said portable device further comprises a RF module.

11. A multimedia distribution system comprising:
a control unit to process data from a data source, an internet linking module coupled to said control unit to allow said multimedia distribution system linking to an internet,
a first WLAN module coupled to said control unit to transfer data; and
at least one client with a second WLAN module coupled to said first WLAN module,
and a data output coupled to said second WLAN module to output said data.

12. The system as set forth in claim 11, wherein said at least one client further comprises an instruction input interface.

13. The system as set forth in claim 11, wherein said first and second wireless local area network (WLAN) module includes Bluetooth standard compatible module, Wi-Fi standard compatible module, 802.11x standard compatible module, WiMAX (Worldwide Interoperability for Microwave Access) standard compatible module.

14. The system as set forth in claim 11, wherein said data source include local data source including DVD player, VCD player, MPEG player, WAN player, and remote data source including SAT TV, digital TV, web-TV, content service provider or network service provider.

15. A method of playing a real time playing mode via a portable device, comprising:
implanting a real time play module and a WLAN module to said portable device to allow a user performing a real time playing;
coupling a content service provider via said WLAN module;
activing said real time play module to couple to said content service provider;
selecting a desired audio or video file through said real time play module;
transmitting data streams from said content service provider to said portable device; and
playing said data streams.

16. The method of claim 15, wherein said WLAN module includes 802.11x, Bluetooth or WiMax.

17. The method of claim 15, wherein said real time play module further comprising a core unit for performing said real time playing mode, a video selector and a music selector coupled to said core unit, a station selector coupled to said core unit.

18. The method of claim 15, wherein said portable device further comprises a RF module.

19. A method of playing a real time playing mode via WLAN module, comprising:
implanting first and second WLAN module to a control terminal and a client terminal, respectively;
inputting instruction from said client terminal to said control terminal via said first and second WLAN module, wherein said control terminal is responsive to said instruction to send a data to said client terminal; and
outputting said data from said client terminal.

20. The method as set forth in claim 19, wherein said instruction is employed an instruction input interface for selecting a desired channel or linking an internet network.

21. The method as set forth in claim 19, wherein said first and second wireless local area network (WLAN) module includes Bluetooth standard compatible module, Wi-Fi standard compatible module, 802.11x standard compatible module, WiMAX (Worldwide Interoperability for Microwave Access) standard compatible module.

22. The method as set forth in claim 19, further comprising performing a step of decoding said data from a remote data source after said performing said instruction.

23. The method as set forth in claim 19, wherein said data is provided by a remote data source including SAT TV, digital TV, web-TV, content service provider, network service provider or a local data source including DVD player, VCD player, MPEG player, WAN player.
